(19) United States
(12) Patent Application Publication
(10) Pub. No.: US 2008/0030856 A1
(43) Pub. Date: Feb. 7, 2008

(54) Breathable retroreflective material for high visibility safety apparel and reflective apparel

(76) Inventor: Tao-Ming Tom King, San Diego, CA (US)

Correspondence Address: TAO-MING TOM KING, 4907 MORENA BLVD. SUITE 1407, SAN DIEGO, CA, 92117, US

(21) Appl. No.: 11/496,687

(22) Filed: Aug. 1, 2006

(51) Int. Cl. G02B 5/128

(52) U.S. Cl. 359/536; 359/518

(57) ABSTRACT

A retroreflective system comprising a monolayer of microsphere lenses arrayed in form of duplicative matrixes, the matrix is a group of micro graphic shapes line up in rows and columns, a matching binder layer of the above matrixes and a base layer of fabric or other substance. The reflective system will not fully covered the reflective area to allow seepage of moisture or air. The reflective system may comply with highest level in prevailing retrorflective code for safety garments.

### RELATED U.S. PATENT DOCUMENTS

| | | | Confirmation |
|---|---|---|---|
| Application No. | Filing Date | Confirmation No. | Date |
| 60/729.600 | Oct. 25, 2005 | 9694 | Nov. 08, 2005 |

### CROSS REFERENCE TO RELATED APPLICATIONS

U.S. Patent Documents.

| | |
|---|---|
| 4,103,060 A * July 1978 | Bingham et al. |
| 4,263,345 A * April 1981 | Bingham |
| 4,404,494 A August 1983 | Pernicano et al. |
| 5,070,436 A December 1991 | Alexander et al. |
| 5,588,156 A December 1996 | Panton, Jr. |
| 5,674,605 A October 1997 | Marecki |
| 4,187,332 February 1980 | Fouche, Jr. |
| 6,110,558 A August 2000 | Billingsley et al. |
| 6,153,128 A * November 2000 | Lightle et al. |
| 6,859,941 B2 Mar. 1, 2005 | Koppes |

### BACKGROUND OF THE INVENTION

The safety of people who expose to traffic hazards will be improved by wearing high visibility apparel.

For individual exposed to higher risk of traffic injury, the safety garments often required to comply with visibility standards such as American National Standards Institute for High Visibility Safety Apparel, ANSI/ISEA 2004, BS EN471 and AS/NZ etc.

For other group of people who wish to have safety measures of reflectivity for garment they wear, who may also concern about fashionable, and comfortable.

The proposed invention will allow safety garment not only to comply with the reflectivity standards but also add on comfort and appearance.

### BRIEF DESCRIPTION OF THE INVENTION

The proposed invention is a retroreflective material fully covered by pervious retro reflective system. The advantage of the proposed invention is breathable, that the air and vapor may seep through the reflective system that it will add to the comfortable of the wearer. The reflective system can be flexibly design to various graph pattern to improve the appearance. Also it is softer and more flexible that will add to the comfort. It can be cut down to stripes or cut to other shapes to be attached to garments yet still comply with the minimum requirement of prevailing High Visibility Safety Apparel Standards in providing high visibility safety garments to the highest class. Also, it may be utilized as the base fabric of making retroreflective high performance garment. Also, it can be transferred to other base fabric.

An example of one typical standard, ANSI/ISEA 107-1999, of retroreflective garment is as below table 1, where the requirement of background material area and the retroreflective area are specified.

TABLE 1
ANSI/ISEA 107-1999, Minimum areas of visible material

| Class of Garment | 1 | 2 | 3 |
|---|---|---|---|
| Back Ground | 0.14 sm | 0.50 sm | 0.8 sm |
| Material exposed | (217 si) | (775 si) | (1240 si) |
| (s.in.) | | | |
| Retroreflective or | 0.10 sm | 0.13 sm | 0.2 sm |
| combined | (155 si) | (201 si) | (310 si) |
| performance | Level 2 | Level 2 | Level 2 |
| material used in | (Table 5) o | (Table 5) or | (Table 5) or |
| conjunction with | Level 1 | Level 1 | Levl 1 |
| background | (Table 6) | (Table 6) | (Table 6) |
| material | | | |
| Combined- | 0.20 sm | | |
| performance | (310 si) | | |
| material used | Level 2 | | |
| without background | (Table 5) | | |
| material | or Level 1 | | |
| Photometric | (Table 6) | | |
| performance | | | |

The convention approach to meet the above standard in providing the safety garment is to apply continuous solid reflective stripe or stripes to meet the minimum requirement of retroreflective and background material both in reflectivity and reflective area. All letters, logos, pattern or space area either covering the retroreflective material and/or background material or empty space will be subtracted from the required area as in Table 1. The garment designer must put on additional reflective area to compensate for the loss.

By comparison, the proposed retroreflective material is much soft in looking as well as in feeling. Also, the invisible space between the micro shapes and matrix, there it is pervious and do allow heat and moisture from the body breath through entire retroreflective material area.

In addition, the proposed invention does allow logo, letter and patterns to be visible on the reflective material while full covered. In addition, due to the proposed invention is composed of micro shapes of dot, square, or other shapes in a form of matrix as shown in FIG. 4. The retroreflective system may apply to stretchable base fabric and become stretchable retroreflective fabric, which is desirable for the group of people in favor to sports and safer. Also, the micro shape matrix allows the moisture and heat of the body to pass through, that the retroreflective material may laminated with TPU (Thermoplastic Polyurethane Film) and become water resistant, wind break, moisture control and retroreflective high performance fabric.

The proposed invention improves the appearance of the traditional retroreflective material. That graphic figures can be appeared on the solid retroreflective material surface without taking away the function of retroreflective reflectivity.

The proposed invention is breathable and adds to the function to the high visibility garments. Therefore, the proposed invention not only provides a means of decorative to the high visibility safety garment for the group people exposed to hazardous vehicular traffic but also provides the group of people in favor of sports and life style.

The proposed invention may use together with breathable, water resist, water proved fabric for high performance application.

Also, the proposed invention may apply to other fashionable functional fabric, that provides people a choice of wearing high visibility garment and safer.

### BRIEF DESCRIPTION OF THE SEVERAL VIEW OF THE DRAWINGS

FIG. 1 is a front view of a high visibility safety garment with the proposed invention cut into stripes and sew on the garment as the retroreflective portion of the garment. The proposed invention will be enable the garment to meet the highest requirement of ANSI/ISEA 107 2004 or other prevailing safety standards.

FIG. 2 is a front view of a high visibility reflective sportswear utilizing the proposed invention as base fabric. The garment do able to have all the high tech fabric functions such as breathable, wind proof, water proof, moisture control, as well as retro reflective for the entire garment.

FIG. 3 shows a reflective trim using two types of continuous coverage of different matrixes. By adjusting the density ratio of these two matrix, the subject reflective trim does able to meet the highest level retro reflectivity as required by the code.

FIG. 4. shows examples of variety of matrix, with different density. The proposed invention may use any graphic design, number or letters as a unit matrix.

FIG. 5 shows the cross section of the reflective fabric, that the micro lens grouped in matrixes of different density.

FIG. 6 shows logos and letters can appear on the reflective fabric using the combination of different matrixes.

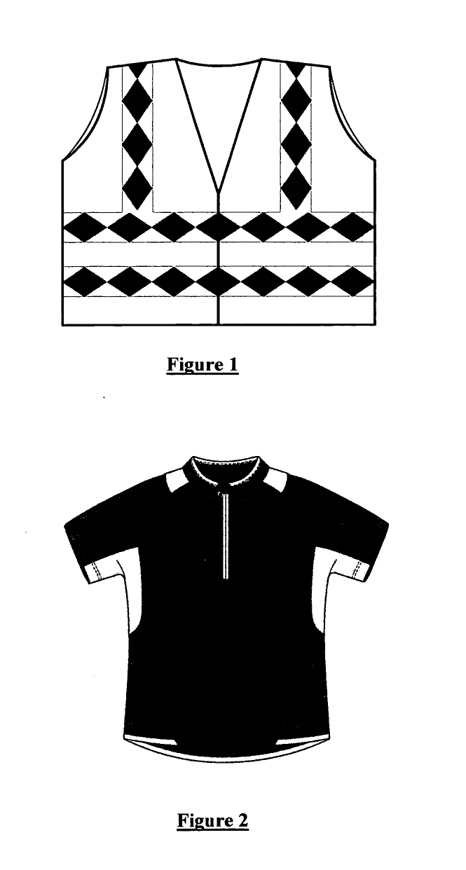

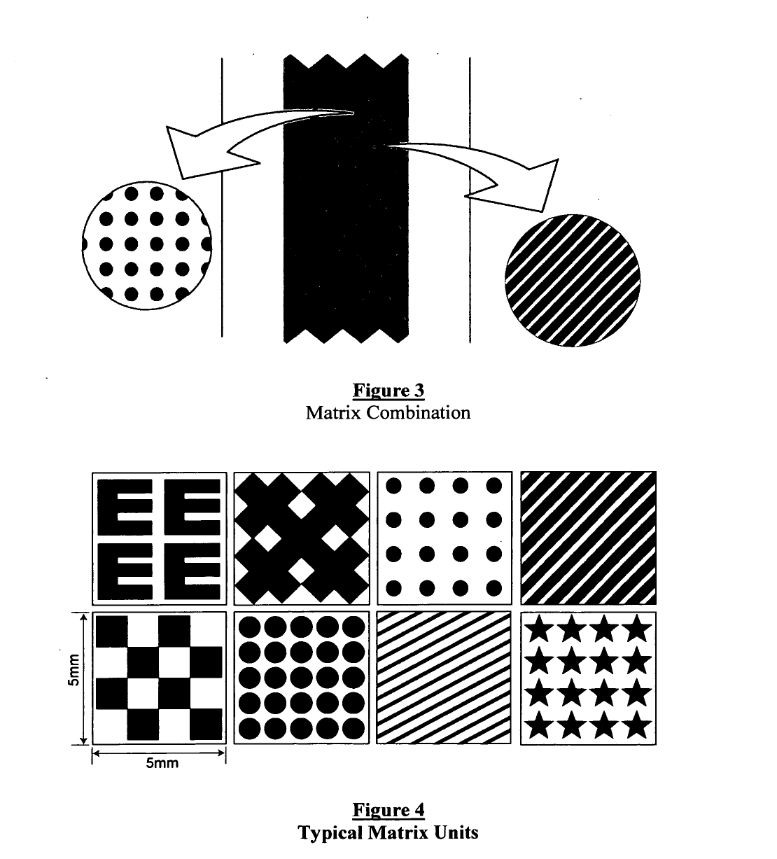

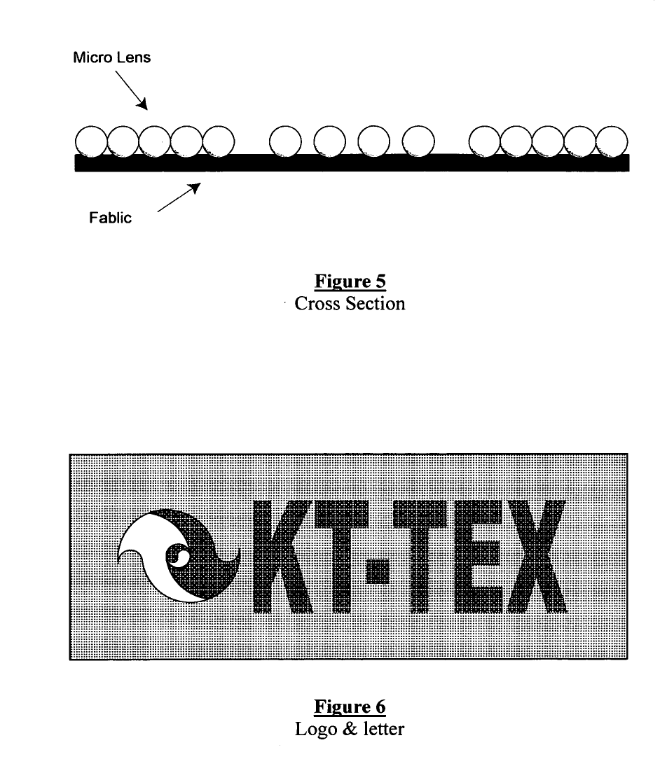

### DETAILED DESCRIPTION OF THE INVENTION

The proposed invention of retroreflective material consists of micro retroreflector and background material for use in high visibility safety garment and or in fashion garment. The appearance of the retroreflective material fully covered with graphic pattern, however the covering is pervious. The graphic pattern is formed by arranging the micro retroreflector in a form consists many micro matrix of shapes and density. Each type of matrix may contain different shape of group of reflectors and in different the density that visible graphic shape including but not excluding floral, logo and letters, can appear on the retroreflective material without covering up the retroreflective surface area. Utilizing different combination of matrix, the retroreflective material can comply with the related standards of High Visibility Safety Apparel. In addition, because the retroreflective material is continuous, the entire retroreflective material area can fully utilized for the required retroreflective area as table 1, minimum areas of visible material, in above standards. The density of the micro shapes in matrix form may be adjusted. That in higher density, the retroreflective may meet the highest level of reflectivity required by current standards. That in lower density, the micro shapes and matrix can blend in with background material as color patterns for use in fashionable matter. The proposed invention can be the combination of one or more style of above matrix with one or more density of percentage coverage, that visual and functional effect can be achieved.

The proposed invention containing various matrixes of groups of retro reflective lenses with different style and density, that the retro reflectivity for each matrix ranged from 550 cd/lx/sm for 95% density to anything in the range of 50 cd/lx/sm for about 8% density. For the lower density, the color of the backing material will be prevail. That a color pattern will be appeared on the retro reflective fabric while the full fabric is still consider covered with retro reflect system. The retroreflective reading of the combined performance of the mixed matrix is proportional to the average according to the ratio of the matrixes. As required in American National Standard ANSI/ISEA for High-Visibility Safety Apparel, shows a minimum required value of retroreflective coefficient Rmin=330 cd/lx/sm. The combination for matrix of 550 cd/lx/sm to 110 cd/lx/sm can achieve retroreflective reading above 330 cd/lx/sm. The variation of different matrix will define the color and shape of the graph, letter and or alphabets. Also, because the matrixes are not full cover by micro glass lenses that the fabric maintain breathable, stretchable and feel softer than full covered traditional reflective fabric.

Since the proposed invention maintained the original characteristic of fabric; the fabric can become part of the garment base fabric. Therefore the retroreflective fabric of the proposed invention, may apply to more variety of garments including uniforms, sportswear and or other garment as in FIG. 2, and increase safety to more groups of people.

What is claimed is:

1. A retro reflective fabric with micro glass bead retroreflective system on various type of fabric. The retroreflective system consists of micro lens grouped in different pattern of matrix in various density to form a visible logo, alphabet or other graphic shapes. The retroreflective fabric does meet ANSI/ISEA 2004 or other prevailing specifications.

2. A retro reflective fabric with micro glass bead retroreflective system on various type of fabric. The retroreflective system consists of micro lens grouped in different pattern of matrix in various density to form a visible logo, alphabet or other graphic shapes.

3. A garment consist of the retroreflective fabric in part or in whole, constructed to comply with ANSI/ISEA 2004 or other prevailing standards. The retroreflective fabric consists of micro lens, grouped in different pattern of matrix in various density to form a visible logo, alphabet or other graphic shapes.

4. A garment constructed by the retroreflective fabric in part or in whole. The retroreflective fabric comprises of retroreflective system of micro lens, grouped in different pattern of matrix in various density to form a visible logo, alphabet or other graphic shapes.

5. A retro reflective transfer film with micro glass bead retroreflective system on various type on the film. The retroreflective system consists of micro lens grouped in different pattern of matrix in various density to form a visible logo, alphabet or other graphic shapes. The retroreflective film does able to be transferred to fabric to meet ANSI/ISEA 2004 or other prevailing specifications.

6. A retro reflective transfer film with micro glass bead retroreflective system on various type on the film. The retroreflective system consists of micro lens grouped in different pattern of matrix in various density to form a visible logo, alphabet or other graphic shapes. The retroreflective film does able to be transferred to fabric or other substance.
